(19) United States
(12) Patent Application Publication
(10) Pub. No.: US 2024/0126612 A1
(43) Pub. Date: Apr. 18, 2024

(54) RESOURCE ALLOCATION DEVICE, RESOURCE ALLOCATION METHOD, AND RESOURCE ALLOCATION PROGRAM

(71) Applicant: Nippon Telegraph and Telephone Corporation, Tokyo (JP)

(72) Inventors: Ryohei SATO, Musashino-shi, Tokyo (JP); Yuichi NAKATANI, Musashino-shi, Tokyo (JP)

(21) Appl. No.: 18/276,474

(22) PCT Filed: Feb. 12, 2021
(86) PCT No.: PCT/JP2021/005175

§ 371 Date: Aug. 9, 2023

(51) Int. Cl. G06F 9/50

(52) U.S. Cl. CPC G06F 9/5044

(57) ABSTRACT

A resource allocation device includes: a request receiving unit that receives a request to allocate a state management unit for sharing a state for each group composed of a plurality of user terminals within a group, to any of a plurality of DCs deployed in a distributed cloud environment; and an allocation calculation unit that calculates an allocation cost of allocating the state management unit to each DC by using an allocation index corresponding to a requirement requested by the group, and determines a DC to which the state management unit is allocated, in accordance with the allocation cost.

### TECHNICAL FIELD

The present invention relates to a resource allocation device, a resource allocation method, and a resource allocation program.

### BACKGROUND ART

The distributed cloud environment is an architecture in which DC (data center) is distributed and arranged in an NW (Network) (NPL 1, 2). The DC provides computer resources (resources) for offloading (acting over) processing conventionally carried out by a server or a user. Hereinafter, a state management unit will be exemplified as an object to be allocated to the DC. The “state” is data used for a service to be exchanged in real time among a plurality of users. The “state management unit” is a processing unit that updates a state managed by the state management unit itself on the basis of access contents received from each user and shares the updated state with each user.

FIG. 7 is a configuration diagram of an online system 9z1 before a state management unit 5z is offloaded.

In the online system 9z1, a service providing device 1z provides a service for data-sharing the state in real time among a plurality of user terminals 4z. The state managed by the state management unit 5z is, for example, as described below.
Online game: The position, acceleration, motion, equipment of an avatar, damage determination, and status of the impossibility to fight, and the like.
XR (Extended_Reality): The motion and five sense information of the avatar (user), an event occurring in a virtual world, and the like.
Online conference: Audio/video data presenter authority and mute settings for users and screen sharing. In the online system 9z1, since a communication distance between the service providing device 1z and each user terminal 4z is long, a large communication delay causes deterioration of service quality.

FIG. 8 is a diagram showing the configuration of an online system 9z2 after the state management unit 5z is offloaded to a DC 3z.

In the online system 9z2, a device for operating the state management unit 5z is offloaded from the service providing device 1z to the DC 3z close to a user terminal 4z. By this off-load, the following effects can be obtained.
User: Reduction of calculation cost and delay.
Telecommunications entrepreneur: Reduction of the amount of traffic and congestion.
Service provider: Reduction of the server load and maintenance cost.

That is, in order to improve the service quality, it is important to select, from among a plurality of DC 3z candidates, which DC 3z the state management unit 5z should be arranged in. A resource allocation method for obtaining a delay between each user terminal 4z and reducing the maximum value (maximum E2E delay) of the delay is described in NPL 3.

### CITATION LIST

### Non Patent Literature

[NPL 1] Alicherry and T.V.Lakshman, “Network aware resource allocation in distributed clouds,” in 2012 Proceedings IEEE INFOCOM, pp. 963-971, 2012.
[NPL 2] M. Mukherjee, L. Shu, and D. Wang, “Survey of fog computing: Fundamental, network applications, and research challenges,” in IEEE Communications Surveys & Tutorials, Vol. 20, No. 3, pp. 1826-1857, 2018.
[NPL 3] A. Kawabata, B.C.Chatterjee, S. Ba and E. Oki, “A Real-Time Delay-Sensitive Communication Approach Based on Distributed Processing,” in IEEE Access, vol. 5, pp. 20235-20248, 2017.

### SUMMARY OF INVENTION

### Technical Problem

Even a user who uses the environment of the same online system allowed to execute various applications for each group of users. In this case, for example, the following problems are defined.
A plurality of DCs and a plurality of users are scattered in the NW.
A relatively small group of users (e.g., 2 to 10 people) has been formed by users.
No user belongs to a plurality of groups.
Each of the state management units of all the groups should be accommodated in an appropriate DC.

It is assumed that the following prerequisites have already been set for the above problems.
All the formed groups and members thereof.
Delay time between all users and all DC (e.g., A measurement value of one ping, an average value of a plurality of times).
The number of users that can be accommodated in each DC and delay requirements that the users should satisfy (such as the maximum value of allowable delay).

FIG. 9 is a configuration diagram of a distributed cloud environment 8z when the state management unit is off-loaded to a plurality of DCs.

In the distributed cloud environment 8z, two DCs (DC1, DC2) exist in the NW indicated by the wavy line, and five users (UA1, UA2, UA, UB1, UB2) are accommodated in the DCs. In the example shown in FIG. 9, each user is accommodated in the nearest DC. Thus, the users (UA1, UA2, UB1) are accommodated in the DC1. The Users (UA3, UB2) are accommodated in the DC2.

Here, as described in the above problem definition, it is assumed that the first group (UA1, UA2, UA3: the second character represents group “A”) and a second group (UB1, UB2: the second character represents group “B”) is formed between users are formed. In order for members of the first group to play the same competitive game, a state of UA1 and UA2 (ST1) and a state of UA3 (ST2) need to be shared (synchronized) between DCs. The same applies to the second group.

In addition, service requirements may be different between and application of the first group and an application of the second group.

For example, in a survival game played by the first group, emphasis is placed on having a large number of participants, such as 100 people, and information about opponents is not as strictly required as in fighting games.

On the other hand, in a competitive fighting game played by the second group, the screen information seen by the members and the operation information input by the members need to be reflected quickly (frame by frame) to the opponent side, although the number of players is small, such as one against one.

A method for efficiently performing resource allocation suitable for each group while taking such service requirements into consideration is required. However, the conventional resource allocation technique such as the one in NPL 3 has a plurality of groups, and each group cannot cope with such a complicated situation that requires various service requirements.

Therefore, the present invention mainly aims to perform resource allocation according to requirements for each group formed by a plurality of users.

### Solution to Problem

In order to solve the problems described above, a resource allocation device of the present invention has the following characteristics.

The present invention includes: a request receiving unit that receives a request to allocate a state management unit for sharing a state for each group composed of a plurality of user terminals within a group, to any of a plurality of data centers deployed in a distributed cloud environment; and an allocation calculation unit that calculates an allocation cost of allocating the state management unit to each of the data centers by using an allocation index corresponding to a requirement requested by the group, and determines a data center to which the state management unit is allocated, in accordance with the allocation cost.

### Advantageous Effects of Invention

According to the present invention, resource allocation according to requirements for each group formed by a plurality of users can be performed.

### BRIEF DESCRIPTION OF DRAWINGS

FIG. 1 is a configuration diagram of an online system according to an embodiment.

FIG. 2 is a hardware configuration diagram of a resource allocation device according to the present embodiment.

FIG. 3 is a configuration diagram of a distributed cloud environment in which an allocation calculation unit according to the present embodiment allocates a state management unit for each group.

FIG. 4 is a flowchart showing main processing of a greedy method according to the present embodiment.

FIG. 5 is a flowchart showing subroutine processing of the greedy method shown in FIG. 4 according to the present embodiment.

FIG. 6 is an explanatory diagram for explaining an example of the processing of the greedy method shown in FIGS. 4 and 5 according to the present embodiment.

FIG. 7 is a configuration diagram of an online system prior to offloading the state management unit.

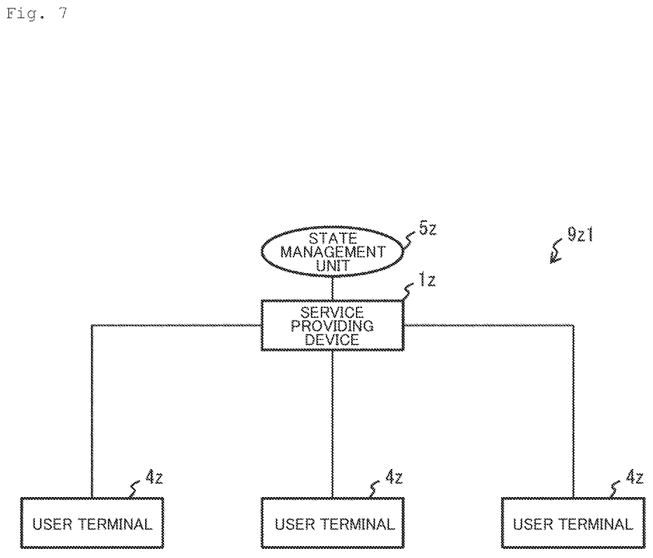

FIG. 8 is a configuration diagram of an online system after the state management unit is offloaded to a DC.

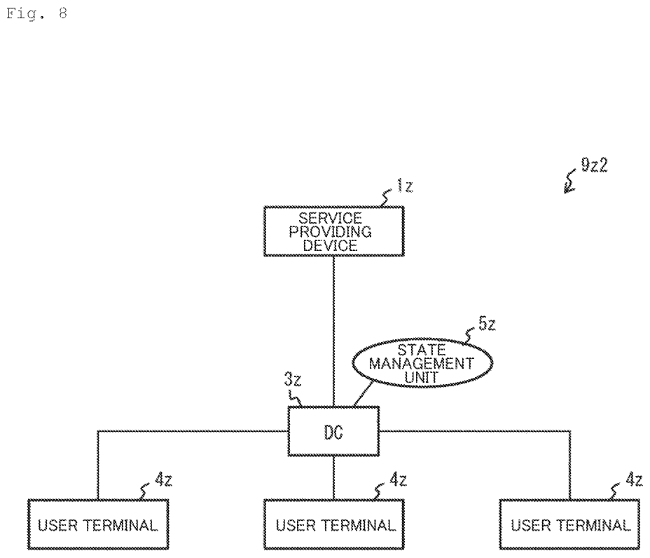

FIG. 9 is a configuration diagram of a distributed cloud environment when the state management unit is off-loaded to a plurality of DCs.

### DESCRIPTION OF EMBODIMENTS

Embodiments of the present invention will be described below with reference to the drawings.

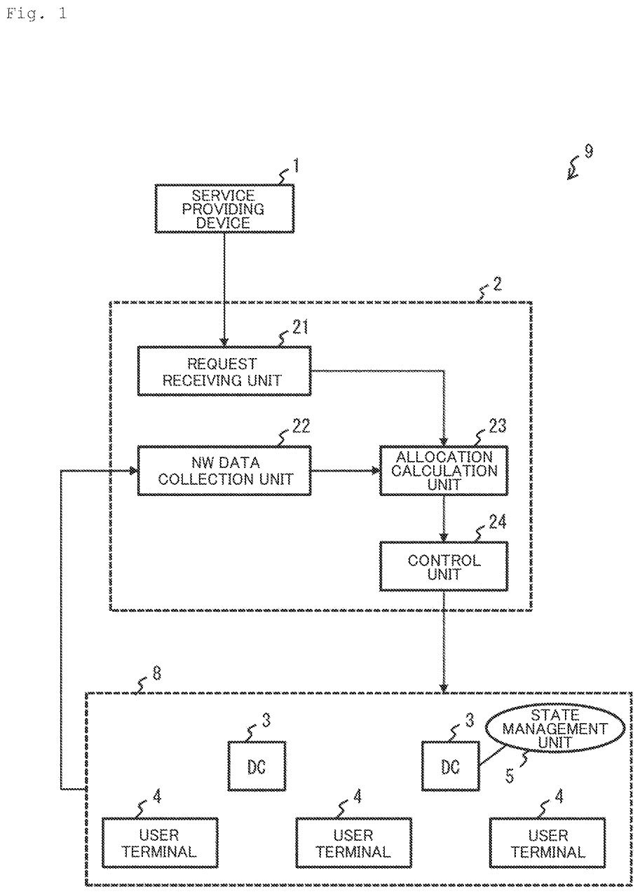

FIG. 1 is a configuration diagram of an online system 9. The online system 9 is configured by connecting a service providing device 1, a resource allocation device 2, and a distributed cloud environment 8 through a network. In the distributed cloud environment 8, a service that allows state data to be shared in real time among a plurality of user terminals 4 is provided.

Therefore, state management units 5 manage the states of the respective groups. Each state management unit 5 is arranged in one of the DCs 3.

First, the resource allocation device 2 performs group matching processing such as (procedure 1A) to (procedure 5A).
(Procedure 1A) A user terminal 4 accesses the service providing device 1.
(Procedure 2A) The user terminal 4 matches an arbitrary (plural) user terminal 4 which is the opposite party sharing the state on the service providing device 1, to form a group. For example, in an online game, “a team mate or an opponent” an opponent sharing a state. In the case of an online conference system, “participants of the same conference” are partners sharing a state.
(Procedure 3A) The service providing device 1 selects an appropriate DC 3 as an off-load destination of the group formed in (procedure 2A), and places the state management unit 5 for each group in the DC 3 to start a service.
(Procedure 4A) A server function (a competitive function in an online game, etc.) for providing a service is previously mounted in the state management units 5 by a VM or a container. The state management units 5 provide services by dating a state of a virtual space or the like in the group.
(Procedure 5A) When the group is disbanded after the end of a match, the user terminal 4 of the disbanded group member is returned to the service providing device 1, and the processing returns to (procedure 2A).

As a detail of (procedure 4A), the DC 3 performs processing for updating the state managed by the state management unit 5 itself of each group. For example, in an online competitive game, each user terminal 4 sends a command to the DC 3 as shown in the following (procedure 1B) to (procedure 4B), and at the same time a virtual space (state) which is already synchronized and generated is received from the DC 3. Thus, the user terminal 4 can acquire the command of the other user terminal 4 only by performing one-to-one communication with the DC 3.
(Procedure 1B) Each user terminal 4 writes its own command in the state management unit 5 on the DC 3. For example, command for advancing its own avatar forward is sent by using a controller.
(Procedure 2B) The state management unit 5 on the DC 3 integrate and synchronize commands of (procedure 1B) from each user terminal 4. For example, the avatar of each user is caused to execute a motion and action in accordance with a command received from each user terminal 4. That is, the virtual world after a slightly longer period of time than before is generated as a state.
(Procedure 3B) The state management unit 5 on the DC 3 uses information of (procedure 2B) to render (image) the virtual world, and transmits the state to all the user terminals 4. For example, the state management unit 5 distributes (one frame of) a game screen reflecting commands of all the user terminals 4.
(Procedure 4B) Each user terminal 4 receiving the state transmits the command again. For example, when seeing an attack from the enemy, an avoidance command is input. Then, the processing returns to (procedure 1B).

Although an example of an online competitive game is described above, in the above-described manner, the distributed cloud environment 8 may be applied to a case in which a plurality of specific modules are combined to obtain a final processing result in an IoT (Internet of Things) environment or the like. For example, a user terminal 4 for a weather prediction module, a user terminal 4 for a soil analysis module, and a user terminal 4 for a crop analysis module are individually prepared. Then, the three modules are grouped, and a processing unit (processing unit corresponding to the state management unit 5) for receiving the output result of the module group belonging to the group, processing them and managing a field is arranged in the DC 3.

In (procedure 3A) the resource allocation device 2 selects a DC 3 in which the state management unit 5 offloaded from the service providing device 1 is to be arranged (hereinafter referred to as “DC arrangement”), in accordance with a requirement for each group formed by a plurality of users (e.g., a requirement for each application used by the group or a requirement for each service used by the group). Therefore, the resource allocation device 2 includes a request receiving unit 21, an NW data collection unit 22, an allocation calculation unit 23, And a control unit 24.

The request receiving unit 21 receives a request for each group including a group configuration and a user delay requirement from the service providing device 1. This request a content of allocating the state management unit 5 for exchanging data for each group composed of a plurality of user terminals 4, to any of a plurality of DCs 3 arranged in the distributed cloud environment 8.

The NW data collection unit 22 measures and collects NW data including delay information between each user terminal 4 and each DC 3 and free capacity (the number of allocatable users) information of each DC 3 from the distributed cloud environment 8.

The allocation calculation unit 23 calculates the DC arrangement for each group according to a resource allocation scheme (hereinafter referred to as “scheme”) on the basis of a request from the request receiving unit 21 and NW data from the allocation calculation unit 23. The scheme information for determining to which DC the state management unit 5 is to be allocated (how much and what policy is to be allocated (which allocation indicator is primarily focus on), and the performance of the distributed cloud environment 8 strong depends on the scheme.

In the scheme, the resource allocation device 2 may receive the request from the service providing device 1.

Alternatively, the allocation calculation unit 23 may obtain the scheme by referring to the database on the basis of the application type received as a request from the service providing apparatus 1 by the resource allocation device 2. A scheme corresponding to each application type is registered in advance in the database.

Alternatively, the allocation calculation unit 23 may receive the designation of the scheme from members of the group. The control unit 24 allocates each of the state management units 5 to each of the DCs 3 according to the DC arrangement from the allocation calculation unit 23.

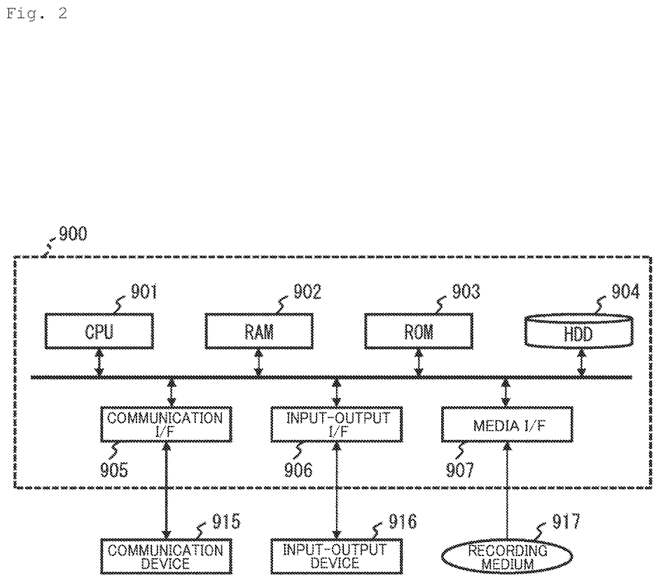

FIG. 2 is a hardware configuration diagram of the resource allocation device 2.

The resource allocation device 2 is configured as a computer 900 that includes a CPU 901, a RAM 902, a ROM 903, an HDD 904, a communication I/F 905, an input-output I/F 906, and a media I/F 907.

The communication I/F 905 is connected to an external communication device 915. The input-output I/F 906 is connected to an input-output device 916. The media I/F 907 reads data from a recording medium 917 and writes data into the recording medium 917. Further, the CPU 901 executes a program loaded into the RAM 902 (the request receiving unit 21, the NW data collection unit 22, the allocation calculation unit 23, a resource allocation program provided in the control unit 24), thereby controlling each processing unit. The program can be distributed via a communication line or can be recorded on the recording medium 917 such as a CD-ROM to be distributed.

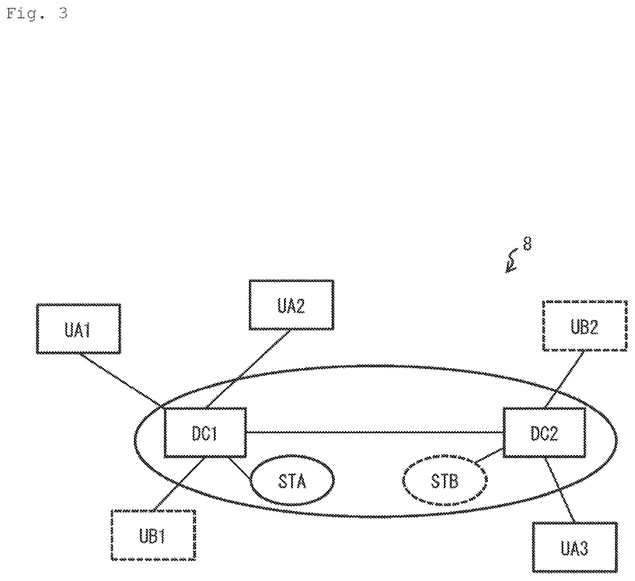

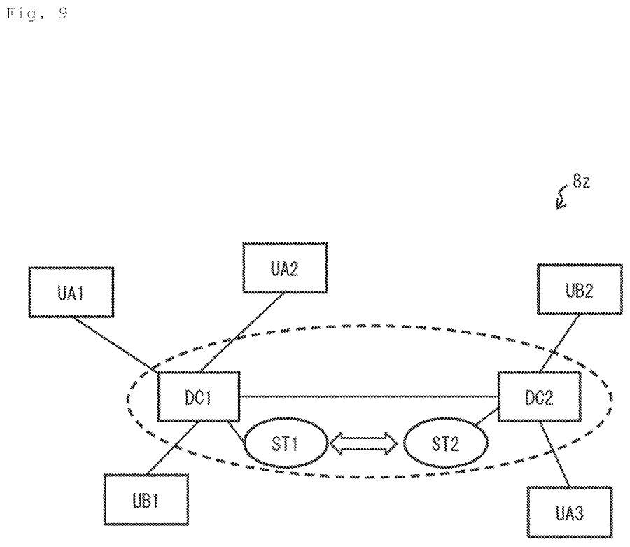

FIG. 3 is a configuration diagram of the distributed cloud environment 8 in which the allocation calculation unit 23 allocates a state management unit for each group. In the distributed cloud environment 8z shown in FIG. 9, since the DC is selected for each user without considering the concept of the group, state sharing between the DC is required. Therefore, communication delay between users has also been increased due to the effect of excessive overhead due to state sharing.

On the other hand, in the distributed cloud environment 8 shown in FIG. 3, the allocation calculation unit 23 performs DC allocation in a group unit. Thus, one state management unit 5 per group is allocated to one DC 3. For example, a state management unit (STA) for the first group (UA1, UA2, UA3) is allocated to the DC1, while the second group (UB1, UB2) is allocated to the DC2. Therefore, overhead at the time of state sharing is suppressed, and strict real-time requirements can be handled.

Also, the allocation calculation unit 23 can make DC arrangement suitable for requirements for each group, by referring to a scheme suitable for an application type for each group from the request.

That is, the allocation calculation unit 23 calculates an allocation cost of allocating the state management unit 5 to each data center, by using, an allocation index of a scheme corresponding to requirements for each group, and determines a data center to which the state management unit 5 is allocated according to the allocation cost. Examples of combinations of application types and schemes will be described below.

“Case 1: Complete synchronization type” is an application for allowing all users belonging to the group to browse the same screen by synchronizing states after waiting for communication of all users belonging to the group one by one. Hereinafter, a complete synchronous application will be described.
One-to-one fighting game.
System for managing the field as described above in the explanation of FIG. 1.

A complete synchronous scheme (allocation index) minimizes “maximum delay in a group.” This is because QoS (Quality of Service) and QoE (Quality of Experience) of the entire group depend on the user with the highest delay.

“Case 2: Semi-synchronization type” is an application that does not (cannot) take strict synchronization between users, and is, for example, a survival game of about 100 FPS (First-Person Shooter). By synchronizing the states without waiting for communication of a user with high delay who belongs to the group, a screen viewed by the user with high delay becomes choppy, and the latest position of the character of the user with high delay is not visible to other users.

The semi-synchronous scheme (allocation index) minimizes the “average delay within a group.” For example, if only about three members of a group of 100 experience large delays, it is sufficient if only three members feel the inconvenience and the remaining 97 are provided with a comfortable environment with a small average delay.

“Case 3: Fair environment type” is a real-time application which requires fairness in a play environment between users, and is exemplified below.
A race game in which about ten people simultaneously run on the same circuit.
In an XR space or the virtual conference room, it is desirable that the time it takes for the user's motion to be reflected in the field of view (motion-to-photonlatency) be 20 [ms] or less.
The number of users who can stay in one space limited in order to prevent the response from being deteriorated even in an application which makes a conversation in a virtual space simulating a real town.

The fair environment scheme (allocation index) minimizes “variance in delay (variance or standard deviation) in a group.”

Generally, the larger the delay, the lower the QoS/QoE, and the more it affects the advantage (e.g., game score) in the virtual world. Therefore, it is desirable to reduce variations in delay in the group, not only in the far environment type application but also in the application of other cases.

Although three types of schemes have been described above, a plurality of allocation indexes may be combined, for example, by simultaneously minimizing “average delay in a group” and “maximum delay in a group” as the semi-synchronous scheme. Simdlarly, as the fair environment scheme, three allocation indexes, “average delay in the group,” “maximum delay in the group,” and “variation in delay in the group,” may be minimized in a balanced manner.

In the following description, a formulation for achieving both minimization and equalization of delay in a group is performed. More specifically, a model capable of evaluating the three assignment indexes in a comprehensive manner will be described. First, parameters used in the model are defined.
The symbol “i∈I” indicates a user i and its set I.
The symbol “j∈J” indicates a group j (j=1, 2, . . . , N) and its set J.
The symbol “k∈K” indicates DCk (k-th DC, K=1, 2, . . . , M) and its set K.
The symbol “Iⱼ⊂I” indicates a set Iⱼ of users belonging to a group j.
The symbol “wᵢⱼ” is a binary variable, and takes a value “1” when the user i belongs to the group j, and takes a value “0” otherwise.
The symbol “dᵢₖ” indicates the delay time between the user i-DCk.
The symbol “Dᵢ” indicates the delay requirement of the user i.
The symbol “Cₖ” indicates the number of users that can be accommodated by the DCk.

These parameters are given to the allocation calculation unit 23 as a request from the request receiving unit 21 and data collected by the NW data collection unit 22.

$$\\ \begin{matrix}[ Math . 1 ] & \\ {a}_{jk} = \frac{{\sum }_{i ∈ {ℐ}_{j}} {d}_{ik}}{‖ {ℐ}_{j} ‖} = \frac{{\sum }_{i ∈ ℐ} {w}_{ij} {d}_{ik}}{{\sum }_{i ∈ ℐ} {w}_{ij}} & ( Equation 1 )\end{matrix}$$

$$\\ \begin{matrix}{v}_{jk}^{{}^{} 2} = \frac{{\sum }_{i ∈ {ℐ}_{j}} {( {a}_{jk} - {d}_{ik} )}^{2}}{‖ {ℐ}_{j} ‖} = \frac{{\sum }_{i ∈ ℐ} {{w}_{ij} ( {a}_{jk} - {d}_{ik} )}^{2}}{{\sum }_{i ∈ ℐ} {w}_{ij}} & ( Equation 2 )\end{matrix}$$

The allocation calculation unit 23 calculates (equation 1) and (equation 2) as allocation indexes. The calculation formula of the maximum delay will be described later in (equation 4). The left side “aⱼₖ” of (equation 1) indicates the average delay of a user i∈Iⱼ when the group j is accommodated in the DCk. The left side “v²ⱼₖ” of (equation 2) indicates the delay dispersion of the i∈Iⱼ when the group j is accommodated in the DCk.

$$\\ \begin{matrix}[ Math . 2 ] & \\ minimize {\sum }_{j ∈ 𝒥} {\sum }_{k ∈ 𝒦} {x}_{jk} {c}_{jk} . & ( Equation 3 )\end{matrix}$$

(Equation 3) represents an objective function of DC allocation. This objective function results in a problem of minimizing the sum of the allocation costs of the group j. The symbol “cⱼₖ” is an allocation cost when the group j is accommodated in the DCk.

The symbol “xⱼₖ” is the calculation result of the allocation calculation unit 23. “Xⱼₖ” is a decision variable and takes a value “1” when the group j is accommodated in the DCk, and takes a value “0” otherwise.

As a concrete calculation formula for obtaining the allocation cost Cⱼₖ by the allocation calculation unit 23, (equation 4) or (equation 5) will be described. As a numerical value indicating the variation in delay, dispersion is adopted in (equation 4), and standard deviation is adopted in (equation 5). By using the standard deviation in place of the dispersion, the term including the square is eliminated, so that the scale of each term can be adjusted to some extent.

$$\\ \begin{matrix}[ Math 3 ] & \\ \begin{matrix}{c}_{jk} = ( 1 - α - β ) {a}_{jk} + α {v}_{jk}^{{}^{} 2} + β {max}_{i ∈ ℐ} {w}_{ij} {d}_{ik} . \\ α , β ≧ 0 , α + β ≦ 1\end{matrix} \} & ( Equation 4 )\end{matrix}$$

$$\\ \begin{matrix}\begin{matrix}{c}_{jk} = ( 1 - α - β ) {a}_{jk} + α {s}_{jk} + β {max}_{i ∈ ℐ} {w}_{ij} {d}_{ik} . \\ α , β ≧ 0 , α + β ≦ 1 , {s}_{jk} = \sqrt{{v}_{jk}^{{}^{} 2}}\end{matrix} \} & ( Equation 5 )\end{matrix}$$

α, β (α, β≥0, α+β≤1) are parameters for adjusting trade-off between the three allocation indexes, and according to service requirements or the like, a service provider, a user, or an NW provider or the like arbitrarily determine the result.

The “1−α−β” of the first term on the right side of (equation 4) is a hyper parameter that emphasizes “average delay within a group” as its value increases.

The “α” of the second term on the right side of (equation 4) is a hyper parameter that emphasizes “variation in delay within a group” as its value increases.

The “β” of the third term on the right side of (equation 4) is a hyper parameter that emphasizes “maximum delay within a group” as its value increases. The calculation formula after of the third term on the right side third is the calculation formula of the maximum delay in the group.

In other words, in (equation 4) or (equation 5), the priority of the three kinds of indexes can be adjusted according to the distribution of the three hyper parameters as follows.
When α=0 and β=0, only the average delay is optimized (Case 2: settings suitable for the semi-synchronization type).
When α≠0 and β=0 (α+β<1) (e.g., α=0.5 and β=0), the average delay and the dispersion (standard deviation) are optimized.
When α=1 and β=0 (α+β=1), only the variance (standard deviation) is optimized (Case 3: settings suitable for the fair environment type).
When α=0 and β≠0 (α+β<1), the average delay and the maximum delay are optimized.
When α=0 and β=1 (α+β=1), only the maximum delay is optimized (Case 1: settings suitable for the complete synchronization type).
When α≠0 and β≠0 (α+β=1), dispersion(standard deviation) and maximum delay are optimized.
When α≠0 and β≠0 (α+β<1), all of average delay, dispersion (standard deviation) and maximum delay are optimized.

$$\\ \begin{matrix}[ Math . 4 ] & \\ \begin{matrix}{c}_{jk} = α {a}_{jk} + β {v}_{jk}^{{}^{} 2} + γ {max}_{i ∈ ℐ} {w}_{ij} {d}_{ik} . \\ α , β , γ \geq 0\end{matrix} \} & ( Equation 6 )\end{matrix}$$

$$\\ \begin{matrix}\begin{matrix}{c}_{jk} = α {a}_{jk} + β {s}_{jk} + γ {max}_{i ∈ ℐ} {w}_{ij} {d}_{ik} . \\ α , β , γ \geq 0\end{matrix} \} & ( Equation 7 )\end{matrix}$$

The allocation calculation unit 23 may use (equation 6) instead of (equation 4) using the variance, as a calculation equation for obtaining the allocation, cost Cⱼₖor may use (equation 7) instead (equation 5) using the standard deviation.

In (equation) 6 and (equation 7) three hyper parameters (α, β, γ) are used. Thus, the degree of freedom of parameter setting is high, but handling (optimum parameter setting) becomes difficult.

The “α” of the first term on the right side is a hyper parameter that emphasizes “average delay within a group” as its value increases.

The “β” of the second term on the right side is a hyper parameter that emphasizes “variation of delay within a group” as its value increases.

The “γ” of the third term on the right side is a hyper parameter that emphasizes “maximum delay within a group” as its value increases.

On the other hand, in (equation 4) and (equation 5), the number of parameters is reduced by one, and the setting range is narrow. However, However, since the weight can be set by ratio, it is likely to be easier to handle than using three types of hyper parameters (α, β, γ).

$$\\ \begin{matrix}[ Math . 5 ] & \\ \begin{matrix}{{subject to}^{}}_{} \\ \\ \\ \\ \\ \end{matrix} \begin{matrix}{\sum }_{k ∈ 𝒦} {x}_{jk} \leq 1 , ∀ j ∈ 𝒥 , \\ {\sum }_{i ∈ ℐ} {\sum }_{j ∈ 𝒥} {x}_{jk} {w}_{ij} \leq {C}_{k} , ∀ k ∈ 𝒦 , \\ {x}_{jk} {w}_{ij} {d}_{ik} \leq {D}_{i} , ∀ i ∈ ℐ , ∀ j ∈ 𝒥 , ∀ k ∈ 𝒦 , \\ {x}_{jk} ∈ \{ 0 , 1 \} , ∀ j ∈ 𝒥 , ∀ k ∈ 𝒦 .\end{matrix} \} & ( Equation 8 )\end{matrix}$$

(Equation 8) represents constraint conditions (subject to) corresponding to the objective function of (equation 3). The constraint conditions as follows.
The number of DCs allocated to one group is 1 or less.
The number of users to be accommodated does not exceed the capacity of each DC.
The actual delay of each user satisfies the delay requirement.

The problem formulated as (equation 3) to (equation 8) is a combination optimization problem, and in order to obtain a global optimal solution, the allocation calculation unit 23 needs to investigate all combinations (brute force calculation). The computational complexity of this problem in this case is huge, being the computational complexity order (n-th power of m), where n is the number of groups and m is the number of DCs.

Therefore, as an approximation algorithm used by the allocation calculation unit 23 in place of the brute force calculation, greedy algorithm and a local search method will be described in order. The allocation calculation unit 23 uses the greedy method alone or uses the greedy method and the local search method in combination. Thus, an optimum solution (or a semi-optimum solution having a score close to the optimum solution) obtained by the brute force calculation can be obtained with a smaller computational complexity than the total brute force calculation.

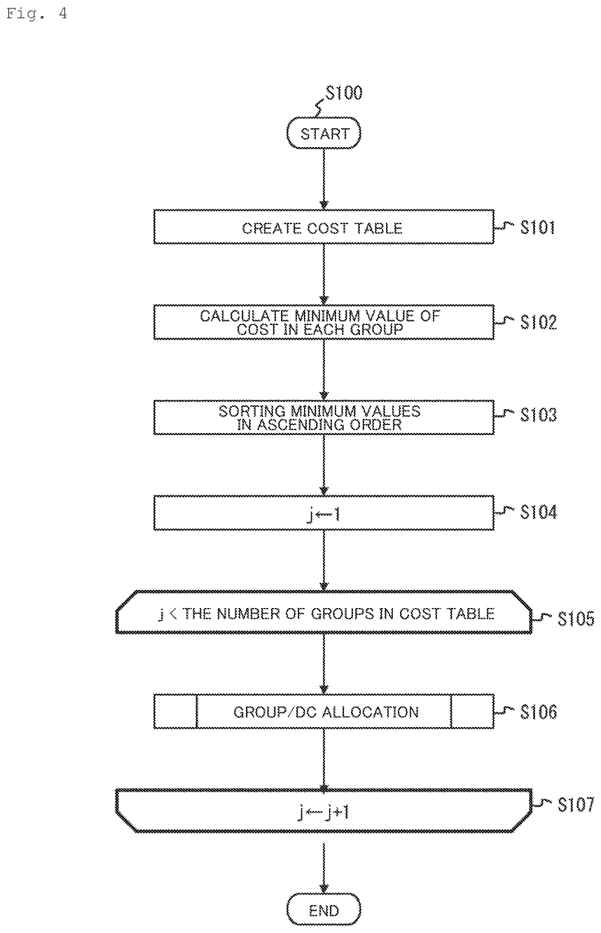

FIG. 4 is a flowchart showing main processing of the greedy method. The greedy method is a method of dividing one large problem into a plurality of small problems, individually evaluating the small problems, and adopting candidates having high evaluation values.

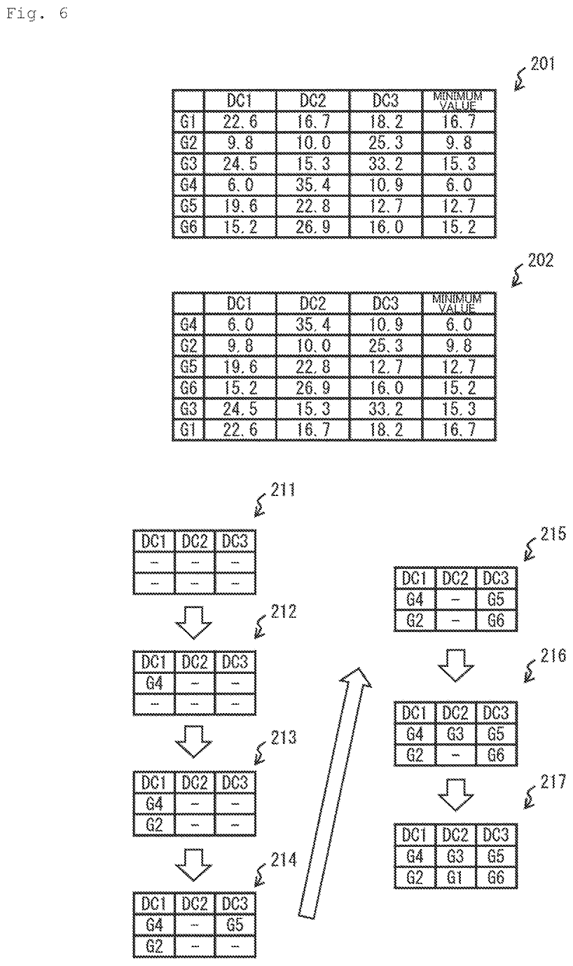

The allocation calculation unit 23 creates a cost table (to be described later in FIG. 6) based on the request from the request receiving unit 21 and the NW data from the NW data collection unit 22 (S101). The allocation calculation unit 23 calculates a minimum value of cost for each group of the cost table created in S101 (S102).

The allocation calculation unit 23 sorts the minimum value of the cost in ascending order for each group of the cost table (S103).

The allocation calculation unit 23 substitutes an initial value 1 in a variable j of the group (S104).

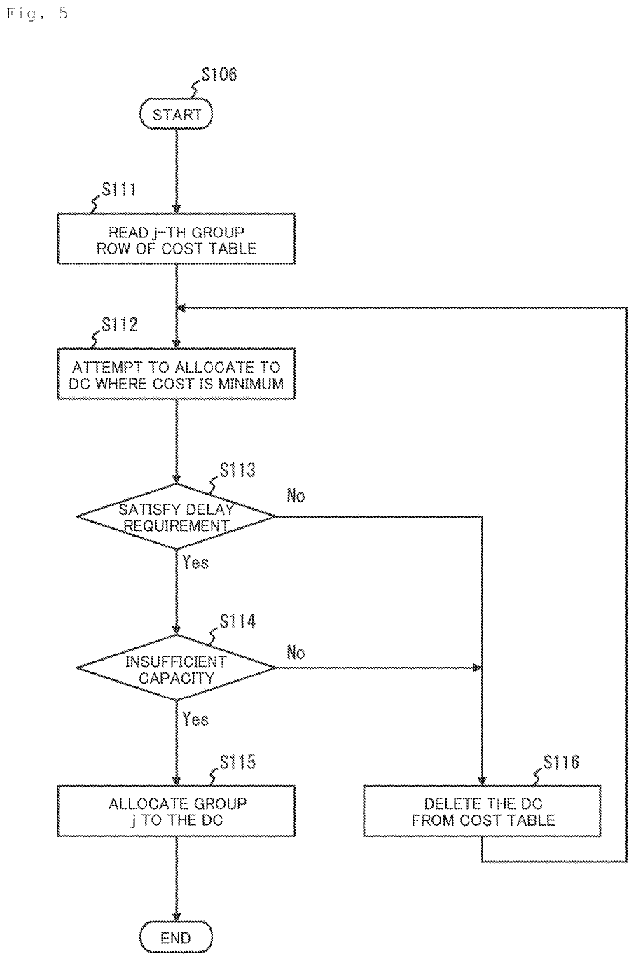

Here, the allocation calculation unit 23 executes a loop for sequentially selecting a group j up to the number of groups of the cost table one by one (S105 to S107), and calls a subroutine (FIG. 5) for performing DC allocation to the group j in the loop (S106).
In the processing of S106, when there is no allocation destination DC that can satisfy a delay requirement of a certain user, or when the capacity of the DC is not sufficient, there is a possibility that a group that cannot be allocated occurs.

FIG. 5 is a flowchart showing the subroutine processing (S106) of the greedy method shown in FIG. 4.

The allocation calculation unit 23 reads a j-th group line of the cost table (S111), and tries to allocate a DC whose cost is minimum (S112).

The allocation calculation unit 23 allocates the group j to a DC when the user delay requirement is satisfied (S113, Yes) and the DC has a sufficient capacity (S114, Yes) (S115). On the other hand, in case of (S113, No) or (S114, No), the allocation calculation unit 23 deletes the DC from the cost table of the j-th group (S116).

FIG. 6 is an explanatory diagram for explaining an example of the processing of the greedy method shown in FIGS. 4 and 5. In order to make the explanation easy to understand, the following problem setting is made in FIG. 6.
Six groups (G1 to G6) are allocated to three DCc (DC 1 to DC 3).
Each DC can be allocated up to two groups. Although the original unit of Cₖ is the number of users, it is designated by the number of groups for simplicity.
For simplicity, the user delay requirements are not taken into consideration (that is, D=∞).
In order to consider only the average delay, α=β=0 is established. Of course, other parameter settings may be used.

A cost table 201 is a two-dimensional table in which the group j is a row and the DCk is a column with respect to the allocation cost Cⱼₖ when the group is accommodated in the DCk. The allocation calculation unit 23 creates the cost table 201 in S101 in FIG. 4. Then, the allocation calculation unit 23 sets the result of sorting the cost table 201 in ascending order by minimum value as a cost table 202 (S103).

DC allocation tables 211 to 217 are obtained by making the calculation result “xⱼₖ” of the allocation calculation unit 23 based on the cost table 202 into a table form. For example, in the DC allocation table 214, two groups of “G4, G2” are allocated to the DC 1, no group is allocated to the DC 2 (symbol “−”), and one group “G5” is allocated to the DC 3.

According to the following procedure, the allocation calculation unit 23 allocates each group to each DC by calling a subroutine of S106 in order from the group positioned at the upper rank of the cost table 202.
(G4 of the first line) The allocation calculation unit 23 allocates the G4 to the DC 1 where the cost is minimum (=6.0) (DC allocation table 211→DC allocation table 212).
(G2 of the second line) The allocation calculation unit 23 allocates G2 to the DC1 where the cost is minimum (DC allocation table 212→DC allocation table 213).
(G5 in the third line) The allocation calculation unit 23 allocates G5 to the DC 3 where the cost is minimum (DC allocation table 213→DC allocation table 214).
(G6 of the fourth line) The allocation calculation unit 23 is about to allocate G6 to DC 1 where the cost is minimum, but the DC1 has insufficient capacity. Therefore, the allocation calculation unit 23 allocates G6 to the DC 3 where the cost the second smallest (DC allocation table 214→DC allocation table 215).
(G3 in the fifth line) The allocation calculation unit 23 allocates G3 to the DC 2 where the cost is minimum (DC allocation table 215→DC allocation table 216).
(G1 of the sixth line) The allocation calculation unit 23 allocates G1 to the DC 2 where the cost is minimum (DC allocation table 216→DC allocation table 217).

The greedy method has been described above with reference to FIGS. 4 to 6.

A pseudo code for explaining the algorithm of the greedy method in detail is exemplified hereinafter. This pseudo code is a procedural language for performing substitution “A←1” (substitution of a value 1 to a variable A) repetitive control “for to end for, while to end while,” and branch control “if to end if.” Further, line numbers (L01, L02, ) for explanation are added to the head of the pseudo code. Each function (function) performs a predetermined calculation based on the input variable given by “Input:˜” and responds (returns) the result of the calculation as an output variable indicated by “Output:˜.”

First, Greedy_Allocation function is shown.
Input: α, β, wᵢⱼ, dᵢₖ, Dᵢ, and Cₖ for ∀i∈I,∀j∈J, and ∀k∈K
Output:xⱼₖ for ∀j∈J and ∀k∈K
L01: function Greedy_Allocation(α,β,wᵢⱼ,dᵢₖ,Dᵢ,Cₖ)
L02: for all i∈I,j∈J,k∈K do
L03: w[i][j]←wᵢⱼ,d[i][k]←dᵢₖ
L04: D[i]←Dᵢ,C[k]←Cₖ
L05: Calculate cⱼₖusing (equation 4) to (equation 7)
L06: c[j][k]←cⱼₖ
L07: end for
L08: for all j∈J do
L08: for all j∈J do
L10: end for
L11: Sort J in ascending order of L
L12: X←GroupDC_Mapping(J,c,w,d,D,C)
L13: return X
L14: end function

In the Greedy_Allocation function (α, β, wᵢⱼ, dᵢₖ, Dᵢ, Cₖ), a cost table is created using α and β (L05) and preprocessing, for performing (L11) DC allocation is performed preferentially starting from the group with the lowest cost in the table. Actual DC allocation is executed by calling the GroupDC_Mapping function with arguments wᵢⱼ, dᵢₖ, Dᵢ, Cₖthe cost table c created here, and the permutation J referring to the cost table as arguments (L12).

In the flow chart shown in FIG. 4, S100 corresponds to L01, S101 to L05, S102 to L09, S103 to L11, and S106 to L12, respectively.

Next, the GroupDC_Mapping function is shown.
L16: function GroupDC_Mapping (J,c,w,d,D,C)
L17: for j′=1 to size(J) do
L18: j←J[j′]
L19: Discover Iⱼfrom I using w
L20: X[j]←DC_Selection(c[j],Iⱼ,d,D,C)
L21: if X[j]=∞ then
L22: D[i]←∞ for ∀i∈Iⱼ
L23: X[j]←DC_Selection(c[j],Iⱼ,d,D,C)
L24: end if
L25: end for
L26: return X
L27: end function

In the GroupDC_Mapping function (J, c, w, d, D, C), the given cost table c is referenced in order (L17) according to the permutation J (i.e., a certain row c[j] in the cost table is extracted) and the DC_Selection function is called sequentially to assign a DC to each group to obtain an allocation (L20, L23). If the DC_Selection function indicates that there is no DC capable of satisfying the user delay requirement D, the delay requirement D is ignored and the allocation is performed.

Note that X[j]←k in L20 and L23 is equivalent to the value 1 (xⱼₖ′=1 if k′=k) if there is allocation, or 0 (xⱼₖ′=0 otherwise) if there is no allocation.

In the flow chart shown in FIG. 4, S104, S105, and S107 correspond to the for sentence of L17 to L25, and S112 corresponds to L20 and L23, respectively.

In addition, the DC_Selection function is shown.

L29: function DC_Selection(c[j],Iⱼ,d,D,C)
L30: tmp←c[j]
L31: while True do
L32: k←arg mink′tmp[k′]
L33: if tmp[k]=∞ then
L34: return ∞
L35: end if
L36: if d[i][k]≤D[i] for ∀i∈I and |Ij|≤C[k] then
L37: C[k]←C[k]−|Ij|
L38: return k
L39: else
L40: tmp[k]←∞
L41: end if
L42: end while
L43: end function

In the DC_Selection function (c[j], Ij, d, D, C), for group member Iⱼamong the DCs that satisfy the delay requirement D for each user and whose remaining capacity C is greater than the group size |Iⱼ| (L36), the DCₖ with the lowest delay cost c[j] [k] is selected for allocation (L37, L38).

In the flowchart shown in FIG. 5, S113 and S114 correspond to L36, S115 to L37, and S116 to L40, respectively. Note that “tmp[k]←∞” in L40 is equivalent to removing the group from the allocation target by setting the group cost to infinity.

As described above, when the greedy method is used alone, the allocation calculation unit 23 can call the Greedy_Allocation function. Thus, by sorting the groups and preferentially allocating the groups, starting from the groups whose costs are low, highly accurate optimization can be done with a small calculation time. On the other hand, the allocation calculation unit 23 may obtain a better solution by combining a proposal method and a local search method.

The following is a pseudo-code of an algorithm in which a proposal method and a local search method are combined.

Input: N,α,β,wᵢⱼ,dᵢₖ,Dᵢ,Cₖ
Output: xⱼₖ
M01: X←Greedy_Allocation(α,β,wᵢⱼ,dᵢₖ,Dᵢ,Cₖ)
M02: Calculate the total cost tₓ of X like (equation 3)
M03: n←0
M04: while n++<N do
M05: Randomize the order of J
M06: X′←GroupDC_Mapping(J,c,w,d,D,C)
M07: Calculate the total cost t′ₓof X′
M08: if t′ₓ<tₓthen
M09: X←X′,tₓ←t′ₓ
M10: end if
M11: end while

In the pseudo codes (M01 to M11), first, the allocation calculation unit 23 executes the Greedy_Allocation function (M01). Next, the alllocation calculation unit 23 executes the GroupDC_Mapping function a fixed number of times (N times of M04) (M06). At this time, the allocation calculation unit 23 changes the permutation of the groups randomly in the part of “sorting of the cost table” (M05). Then, the allocation calculation unit 23 selects the allocation whose entire cost. is the lowest among N times of repetition (M08 to M10). This pseudo code (M01˜M11) may make the allocation cost even smaller than the greedy method, although the additional number of searches to the effect that the GroupDC_Mapping function is repeated N times increases the computational cost. The number N of searches is arbitrarily set by the service provider or the distributed environment operator.

Here, the number of groups given to the request receiving unit 21 is focused and classified as follows.
(Classification 1) The offline allocation is where all groups to be allocated are given to the request receiving unit 21 in advance.
(Classification 2) Batch allocation is where some (a plurality of groups) of groups to be allocated are successively given to the request receiving unit 21 and offline allocation (relatively small scale) is executed each time. For example, in a large-scale system, since several groups are created within, for example, 10 seconds, in this case, there is a need to perform batch allocation every 10 seconds.
(Classification 3) The online allocation is where groups to be allocated are given to the request receiving unit 21 one by one, and the allocation is executed each time the groups are allocated. For example, there are cases where groups are not formed frequently so as to execute batch processing, or where the time from group formation to completion of allocation is desired to be reduced as much as possible.

The Greedy_Allocation function described so far assumes that a coherent number of groups are given to the request receiving unit 21 (offline allocation or batch processing). On the other hand, if the groups to be allocated to the request receiver 21 come sequentially, the following pseudo-code for online allocation may be executed.

Input: α,β,wᵢⱼ,dᵢₖ,Dᵢ, and Cₖ for ∀i∈I, ∀j∈J, and ∀k∈K
Output: xⱼₖ for ∀j∈J and ∀k∈K
N01: while True do
N02: if receive an offload request for group j then
N03: Calculate cⱼₖfor ∀k∈K
N04: c[k]←cⱼₖ
N05: X[j]←DC_Selection(c[j],I_{j,}d,D,C)
N06: if X[j]=∞ then
N07: D[i]←∞ for ∀i∈Ij
N08: X[j]←DC_Selection(c[j],Ij,d,D,C)
N09: end if
N10: return X[j]
N11: end if
N12: end while

In the pseudo codes (N01 to N12) first, upon reception of an allocation request for a group j (N02), the allocation calculation unit 23 calculates all allocation costs cⱼₖ between the group j and each DC(N03), and create a cost table only for the groupⱼ (N04).

Then, the allocation calculation unit 23 executes the DC_Selection function for the group j (N05, N08). In so doing, the allocation calculation unit 23 always monitors the capacity Cₖ=C[k] of each DC and increases the capacity by that amount when the group j leaves the DC.

Below is an example of the number of function calls for each classification to show the computational complexity for each of (Classification 1) to (Classification 3).
(Classification 1) When the number of groups=10 is collectively given as offline allocation, the following is performed.

When only the greedy method is executed in (classification 1), the Greedy_Allocation function is executed once, the GroupDC_Mapping function is executed once, and the DC_Selection function is executed 10 times or more. The number of times the DC_Selection function is called more than 10 times is when there is no DC that can satisfy the user delay requirement (when the return value of line L20 is ∞), and the DC_Selection function is moved to line L23 and called again. When the greedy method and the local search are executed in combination in classification 1, the Greedy_Allocation function is executed once, and then the GroupDC_Mapping function and the DC_Selection function are repeated N times (the Greedy_Allocation function is executed once, the GroupDC_Mapping function is executed 1+N times, and the DC_Selection function is executed (1+N) times or more). N is a parameter which can be arbitrarily set by an operator or the like.
(Classification 2) The number of groups=10 is given in three stages in the order of “group number=5”→“group number=3”→“group number=2” as batch allocation, as follows.

When only the greedy method is executed in (Classification 2), the following is performed.
Execute the Greedy_Allocation function once (when the number of groups is 5)+once (when the number of groups is 3)+once (when the number of groups is 2) for a total of 3 times.
Execute the GroupDC_Mapping function once (when the number of groups is 5)+once (when the number of groups is 3)+once (when the number of groups is 2), for a total of three times.
Execute the DC_Selection function 5 times or more (when the number of groups is 5)+3 times or more (when the number of groups is 3)+2 times or more (when the number of groups is 2), for a total of 10 times or more.

When the greedy method and local search are executed together in (Classification 2) the Greedy_Allocation function is performed once each, and then the GroupDC_Mapping and DC_Selection functions are repeated N times during each batch processing as one set, which is as follows.
Execute the Greedy_Allocation function three times, once each.
Execute the GroupDC_Mapping function 3 times, each (1+N) times.
Execute the DC_Selection function 5×(1+N) times or more+3×(1+N) times or more+2×(1+N) times or more, for a total of 10×(1+N) times or more.
(Classification 3) When the number of groups=10 is given one by one as online allocation, the following is performed. When only the greedy method is executed in (Classification 3), the DC_Selection function is called 10 times, once or twice each, for a total of at least 10 times or more.

It is not possible to execute both the greedy method and local search in (Classification 3). If there is only one group, there is no room for local search because the order of allocation is irrelevant.

### Effects

The resource allocation device 2 of the present invention includes the request receiving unit 21 for receiving a request to allocate the state management unit 5 for sharing a state for each group composed of a plurality of user terminals 4 within a group, to any of a plurality of DCs 3 arranged in the distributed cloud environment 8, and the allocation calculation unit 23 for calculating an allocation cost of allocating the state management unit 5 to each DC 3 by using an allocation index corresponding to requirements requested by the group, and determining the DC 3 as the allocation destination of the state management unit 5 according to the allocation cost.

This allows a user terminal 4, a member of the group, to assign the state management unit 5 to the allocation destination suitable for the application to be executed by the group sharing the state management unit 5. Thus, resource allocation according to requirements for each group formed by a plurality of users can be performed.

The allocation calculation unit 23 obtains delay time between each of the user terminals 4 constituting a group and the DC 3, and the average delay of the obtained delay time is used as an allocation index for the state management unit 5.

Thus, in an application such as a survival game in which many people participate, an allocation destination satisfying the many people can be found.

The present invention is characterized in that the allocation calculation unit 23 determines the delay time between each user terminal 4 and the DC 3 that comprises the group, and the maximum delay of those determined delay times is used as the allocation index for the state management unit 5.

This allows the discovery of a suitable allocation destination for an application that requires strict synchronization in the communication of all users belonging to a group, such as fighting games.

The present invention is characterized in that the allocation calculation unit 23 determines the delay time between each user terminal 4 and the DC 3 that comprises the group and uses the variance or standard deviation of those determined delay times as the allocation index for the state management unit 5.

This allows the discovery of a suitable allocation destination for a real-time application, such as a racing game, where fairness of the playing environment among users is particularly important.

The present invention is characterized that the allocation calculation unit 23 calculates an allocation destination for each group by an approximation algorithm using the greedy method, for a combination optimization problem of minimizing the sum of allocation costs of each group for a request received by the request receiving unit 21.

This allows for the calculation of a reasonable allocation with less computation than a brute force calculation for combination optimization problems.

The present invention is characterized in that the allocation calculation unit 23 calculates the allocation destination for each group by an approximation algorithm that combines the greedy method and the local search method for the combination optimization problem of minimizing the sum of allocation costs of each group for a request received by the request receiving unit 21.

This increases the likelihood of finding even better allocation destinations than if the greedy method were used alone.

### REFERENCE SIGNS LIST

1 Service providing device
2 Resource allocation device
3 DC (data center)
4 User terminal
5 State management unit
8 Distributed cloud environment
9 Online system
21 Request receiving unit
22 NW data collection unit
23 Allocation calculation unit
24 Control unit

1. A resource allocation device, comprising a processor coupled to a receiver and configured to perform operations comprising:
receiving, using the receiver, a request to allocate the processor for sharing a state for each group composed of a plurality of user terminals within a group, to any of a plurality of data centers deployed in a distributed cloud environment; and
calculating an allocation cost of allocating the processor to each of the data centers by using an allocation index corresponding to a requirement requested by the group, and determines a data center to which the processor is allocated, in accordance with the allocation cost.

2. The resource allocation device according to claim 1, wherein the processor is configured to obtain a delay time between each user terminal constituting a group and the data center, and uses an average delay of the obtained delay time as an allocation index of the processor.

3. The resource allocation device according to claim 1, wherein the processor is configured to obtain a delay time between each user terminal constituting a group and the data center, and uses a maximum delay of the obtained delay time as an allocation index of the processor.

4. The resource allocation device according to claim 1, wherein the processor is configured to obtain delay times between each user terminal constituting a group and the data center, and uses a dispersion or standard deviation of the obtained delay time as an allocation index of the processor.

5. The resource allocation device according to claim 1, wherein the processor is configured to calculate an allocation destination of each group by an approximate algorithm using a greedy method, for a combination optimization problem minimizing a sum of allocation costs of each group for a request received by the receiver.

6. The resource allocation device according to claim 1, wherein the processor is configured to calculate an allocation destination of each group by an approximation algorithm using both a greedy method and a local search method, for a combination optimization problem minimizing a sum of allocation costs of each group for a request received by the receiver.

7. A resource allocation method, comprising:
receiving a request to allocate a processor for sharing a state for each group composed of a plurality of user terminals within a group, to any of a plurality of data centers deployed in a distributed cloud environment; and
calculating an allocation cost of allocating the processor to each of the data centers by using an allocation index corresponding to a requirement requested by the group, and determines a data center to which the processor is allocated, in accordance with the allocation cost.

8. (canceled)

9. A non-transitory computer-readable medium storing program instructions that, when executed, cause one or more processors to perform operations comprising:
receiving a request to allocate the one or more processors for sharing a state for each group composed of a plurality of user terminals within a group, to any of a plurality of data centers deployed in a distributed cloud environment; and
calculating an allocation cost of allocating the one or more processors to each of the data centers by using an allocation index corresponding to a requirement requested by the group, and determines a data center to which the one or more processors are allocated, in accordance with the allocation cost.
